(19) United States
(12) Patent Application Publication
(10) Pub. No.: US 2025/0386395 A1
(43) Pub. Date: Dec. 18, 2025

(54) PHYSICAL DOWNLINK CONTROL CHANNEL (PDCCH) SKIPPING IN WIRELESS COMMUNICATIONS

(71) Applicant: Apple Inc., Cupertino, CA (US)

(72) Inventors: Neha Goel, Herndon, VA (US); Divyaprakash P. Bhojkumar, San Jose, CA (US); Murali Narasimha, San Ramon, CA (US); Sreevalsan Vallath, Dublin, CA (US)

(21) Appl. No.: 19/220,239

(22) Filed: May 28, 2025

Related U.S. Application Data
(60) Provisional application No. 63/660,290, filed on Jun. 14, 2024.

(51) Int. Cl. H04W 76/28; H04B 17/318; H04L 1/1812; H04W 52/02; H04W 72/232

(52) U.S. Cl. CPC H04W 76/28; H04B 17/328; H04L 1/1812; H04W 52/0274; H04W 72/232

(57) ABSTRACT

Disclosed are methods, systems, and computer-readable medium to perform operations including: determining a first configured grant (CG) opportunity during a first Connected Mode Discontinuous Reception (CDRX) ON duration; transmitting data during the first CG opportunity; determining a Physical Downlink Control Channel (PDCCH) skip interval, where a beginning of the PDCCH skip interval corresponds to a start of a DRX-retransmission timer subsequent to the first CDRX ON duration, and where an end of the PDCCH skip interval corresponds to at least one of: a beginning of a second CG opportunity, or a beginning of a second CDRX ON duration; and refraining from monitoring the PDCCH during the PDCCH skip interval.

### CROSS-REFERENCE TO RELATED APPLICATIONS

This application claims the benefit of priority to U.S. Provisional Application No. 63/660,290 filed on Jun. 14, 2024, the contents of which are hereby incorporated by reference.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

A user equipment (UE) can communicate with a network according to a Connected Mode Discontinuous Reception (CDRX) mechanism. In general, CDRX is a power-saving mechanism used in a mobile communication system to extend the battery life of UEs. In particular, CDRX allows UEs to periodically turn off their receiver and enter a low-power state (e.g., sleep state or “microsleep” state), and wake up at specific intervals to check for incoming data or signals. Further, a UE can operate in a connected mode during which it can actively communicate with the network while periodically switching between active and low-power states.

During CDRX operation, a UE may monitor one or more downlink channels (e.g., a physical downlink control channel, PDCCH) for control information from the network. To reduce its power consumption, in at least some implementations, the UE can enter a sleep state during certain time intervals, and refrain from monitoring one or more of those downlink channels during those time intervals. For example, in at least some implementations, the UE can enter a low-power state during a PDCCH skip interval during which the UE does not monitor the PDCCH for control information from the network.

In at least some implementations, the PDCCH skip interval can be aligned with a DRX retransmission timer while the UE is in a connected or active mode. For example, the PDCCH skip interval can begin at the start of the DRX retransmission timer, and end at (i) the beginning of a next Configured Grant (CG) opportunity and/or (ii) the beginning of a next CDRX ON duration. This can be beneficial, for example, as it allows the UE to extend the amount of time that it is in a sleep state (e.g., compared to situations in which the UE does not skip PDCCH monitoring according to a PDCCH skip interval).

Further, PDCCH skipping may be particularly beneficial in improving power efficiency of network connections in the context of extended reality (XR) services. In general, XR includes technologies such as augmented reality (AR), virtual reality (VR), and/or mixed reality (MR). With XR services, data streams can include multiple components (e.g., components having one or more portions of graphical data, audio data, textual data, metadata, etc.), and components can have different cadences (e.g., transmission and/or reception periodicities) relative to one another. Further, at least some of the component may be associated with short cadences. For instance, audio data and pose information may be transmitted at short intervals every 10 milliseconds or less. When a UE operates according to traditional techniques (e.g., not performing PDCCH skipping in accordance with the techniques described herein), these factors may make it difficult for a UE to sleep during CRDX, and can lead to increased power consumption by the UE. However, by performing one or more of the PDCCH skipping techniques described herein, the UE can lengthen the time that it sleeps during CRDX, and thus can decrease its power consumption during operation.

In accordance with one aspect of the present disclosure, a method includes: determining a first configured grant (CG) opportunity during a first Connected Mode Discontinuous Reception (CDRX) ON duration; and transmitting data during the first CG opportunity; determining a Physical Downlink Control Channel (PDCCH) skip interval, where a beginning of the PDCCH skip interval corresponds to a start of a DRX-retransmission timer subsequent to the first CDRX ON duration, and where an end of the PDCCH skip interval corresponds to at least one of: a beginning of a second CG opportunity, or a beginning of a second CDRX ON duration; and refraining from monitoring the PDCCH during the PDCCH skip interval.

Implementations of this aspect can include one or more of the following features.

In some implementations, a determination to refrain from monitoring the PDCCH during the PDCCH skip interval can be made absent signaling from a network regarding a PDCCH skip configuration.

In some implementations, a determination to refrain from monitoring the PDCCH during the PDCCH skip interval can be made based on a Reference Signal Receive Power (RSRP) measurement.

In some implementations, the determination to refrain from monitoring the PDCCH during the PDCCH skip interval can be made based on a determination that the RSRP measurement is higher than a threshold value.

In some implementations, a PDCCH is not monitored during the PDCCH skip interval.

In some implementations, the method can include performing micro sleep during the PDCCH skip interval.

In some implementations, the method can include starting a Discontinuous Reception Hybrid Automatic Repeat Request Round Trip Timer (DRX-HARQ-RTT) at an end of the first CG opportunity, where the beginning of the PDCCH skip interval corresponds to an expiration of the DRX-HARQ-RTT.

In some implementations, the method can include receiving, during an active DRX retransmission time, at least one of downlink data or a transmission grant, where the active DRX retransmission time is between the first CDRX ON duration and the PDCCH skip interval.

In some implementations, determining the PDCCH skip interval can be based on determining a configuration with at least one of (i) a low latency bearer or (ii) a low latency Quality of Service Class Identifier (QCI) or Fifth Generation Quality of Service Identifier (5QI).

In some implementations, at least one of the low latency bearer or the low latency QCI can correspond to a 5QI value of 80.

In some implementations, the method can include transmitting data to the network during the first CG opportunity.

In some implementations, the method can be performed by one or more baseband processors.

In some implementations, the method can be performed by the UE.

In accordance with another aspect of the present disclosure, a method includes: transmitting configuration information representing a first configured grant (CG) opportunity during a first Connected Mode Discontinuous Reception (CDRX) ON duration; and refraining from transmitting control information via a Physical Downlink Control Channel (PDCCH) during a PDCCH skip interval, where a beginning of the PDCCH skip interval corresponds to a start of a DRX-retransmission timer subsequent to the first CDRX ON duration, and where an end of the PDCCH skip interval corresponds to at least one of: a beginning of a second CG opportunity, or a beginning of a second CDRX ON duration.

Implementations of this aspect can include one or more of the following features.

In some implementations, the method can also include refraining from transmitting explicit signaling regarding a PDCCH skip configuration.

In some implementations, the method can be performed by one or more baseband processors of a base station.

In some implementations, a Discontinuous Reception Hybrid Automatic Repeat Request Round Trip Timer (DRX-HARQ-RTT) can be started at an end of the first CG opportunity, where the beginning of the PDCCH skip interval corresponds to an expiration of the DRX-HARQ-RTT.

In some implementations, the method can include determining that least one of: downlink data is buffered, or a retransmission grant is pending transmission; and in response, transmitting, during an active DRX retransmission time, at least one of the downlink data or the retransmission grant, where the active DRX transmission time is between the first CDRX ON duration and the PDCCH skip interval.

In some implementations, the refraining from transmitting the control information via the PDCCH during the PDCCH skip interval can be based on a prior transmission of configuration information representing at least one of (i) a low latency bearer or (ii) a low latency Quality of Service Class Identifier (QCI) or Fifth Generation Quality of Service Identifier (5QI).

In some implementations, at least one of the low latency bearer or the low latency QCI can correspond to a 5QI value of 80.

In some implementations, the method can include receiving data during the first CG opportunity.

In some implementations, the method can be performed by one or more baseband processors.

In some implementations, the method can be performed by a base station of the network.

Other embodiments are directed to systems, apparatus, processing circuitry, baseband processors, software (e.g., stored on transitory and/or non-transitory computer readable media) to perform the methods and other operations described herein.

The details of one or more embodiments of these systems, apparatuses, methods, and/or other implementations are set forth in the accompanying drawings and the description below. Other features, objects, and advantages of these systems, apparatuses, methods, and/or other implementations will be apparent from the description and drawings, and from the claims.

### BRIEF DESCRIPTION OF THE FIGURES

FIG. 1 illustrates a wireless network, according to some implementations.

FIG. 2 illustrates operations of a user equipment (UE) during Connected Mode Discontinuous Reception (CDRX) operation, without the performance of Physical Downlink Control Channel (PDCCH) skipping.

FIG. 3 illustrates operations of a UE during CDRX operation with PDCCH skipping.

FIG. 4A illustrates a flowchart of an example method, according to some implementations.

FIG. 4B illustrates a flowchart of another example method, according to some implementations.

FIG. 5 illustrates an example user equipment (UE), according to some implementations.

FIG. 6 illustrates an example access node, according to some implementations.

### DETAILED DESCRIPTION

A user equipment (UE) can communicate with a network according to a Connected Mode Discontinuous Reception (CDRX) mechanism. In general, CDRX is a power-saving mechanism used in a mobile communication system to extend the battery life of UEs. In particular, CDRX allows UEs to periodically turn off their receiver and enter a low-power state (e.g., sleep state or “microsleep” state), and wake up at specific intervals to check for incoming data or signals. Further, a UE can operate in a connected mode during which it can actively communicate with the network while periodically switching between active and low-power states.

During CDRX operation, a UE may monitor one or more downlink channels (e.g., a physical downlink control channel, PDCCH) for control information from the network. To reduce its power consumption, in at least some implementations, the UE can enter a sleep state during certain time intervals, and refrain from monitoring one or more of those downlink channels during those time intervals. For example, in at least some implementations, the UE can enter a low-power state during a PDCCH skip interval during which the UE does not monitor the PDCCH for control information from the network.

In at least some implementations, the PDCCH skip interval can be aligned with a DRX retransmission timer while the UE is in a connected or active mode. For example, the PDCCH skip interval can begin at the start of the DRX retransmission timer, and end at (i) the beginning of a next Configured Grant (CG) opportunity and/or (ii) the beginning of a next CDRX ON duration. This can be beneficial, for example, as it allows the UE to extend the amount of time that it is in a sleep state (e.g., compared to situations in which the UE does not skip PDCCH monitoring according to a PDCCH skip interval).

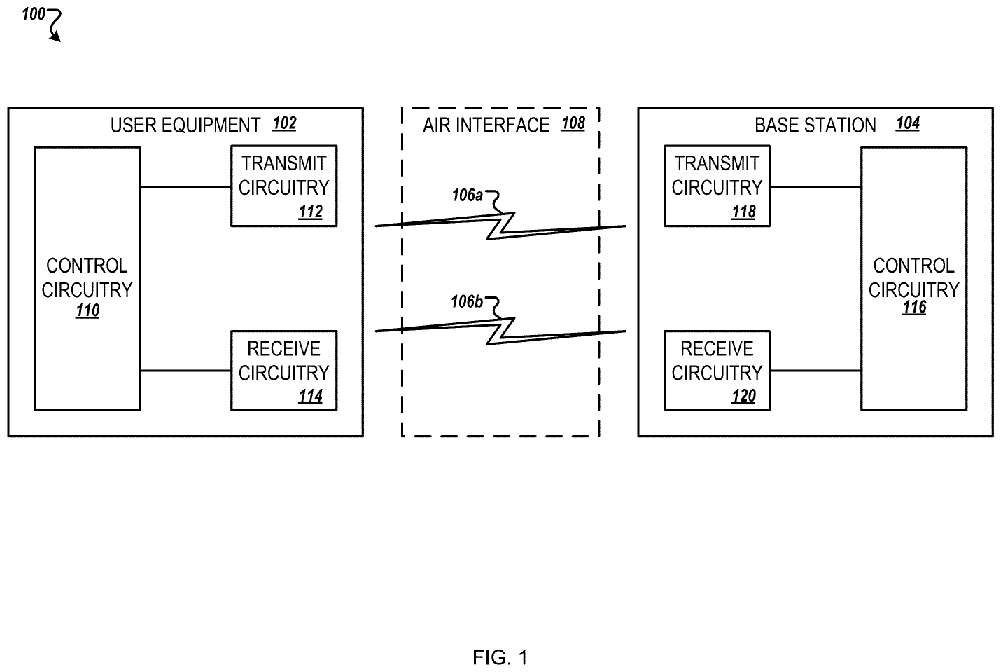

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012;IEEE 802.11ac; or other present or future developed IEEE 802.11 technologies), IEEE 802.16protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE. For instance, the control circuitry 110 can be configured to perform PDCCH skipping in accordance with the techniques described herein.

The transmit circuitry 112 can perform various operations described in this specification. For example, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For example, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

In general, the UE 102 can communicate with a network (e.g., via the base station 104) according to a CDRX mechanism. For example, during CDRX, the UE 102 can periodically turn off transmit circuitry 112 and receive circuitry 114, and enter a low-power state (e.g., sleep state or microsleep state). Further, the UE 102 can periodically wake up (e.g., turn on its receive circuitry 114) at specific intervals to check for incoming data or signals from the base station 104. Further, the UE 102 can operate in a connected mode during which it can actively communicate with the base station 104 while periodically switching between active and low-power states.

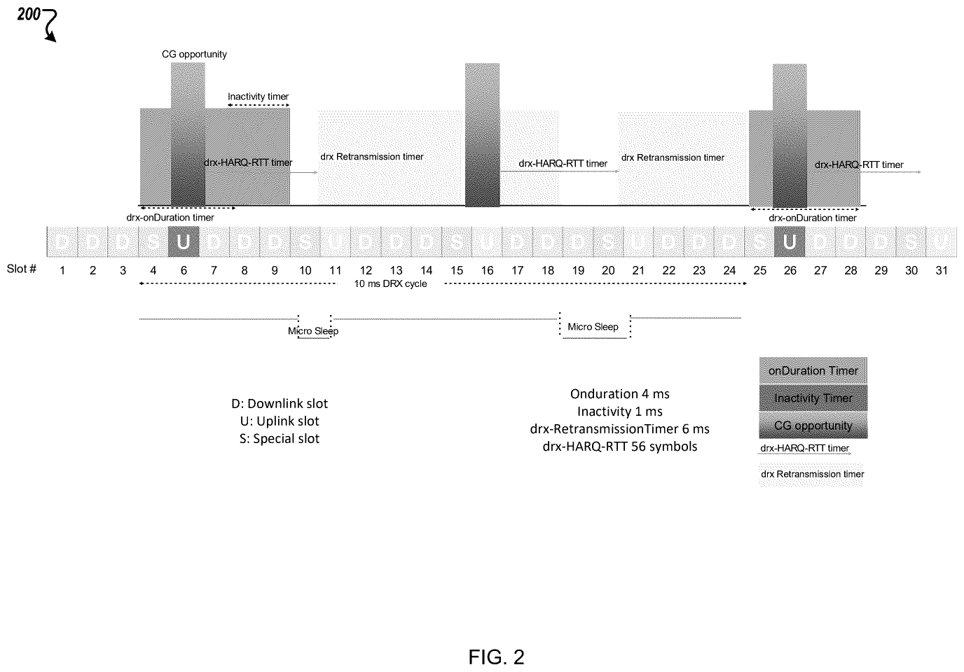

During CDRX operation, the UE 102 can monitor one or more downlink channels, such as a PDCCH, for control information from the base station 104. As an illustrative example, FIG. 2 shows a simplified representation of operations 200 of the UE 102 during CDRX operation, without the performance of PDCCH skipping.

In this example, the UE 102 and the base station 104 communicate according to a time-division duplex (TDD) split of four downlink slots (labeled as “D”) to one uplink slot (labeled as “U”) and one special slot (labeled as “S”). However, in practice, other splits of downlink, uplink, and/or special slots can also be used.

According to FIG. 2, the UE 102 is configured to be in an active state during the CDRX ON duration from slots 4-8 (corresponding to the length of the drx-onDuration timer). During this time, the UE 102 can transmit data to the base station 104 (e.g., during slots allocated for uplink transmission, labeled as “U”) and/or receive data from the base station 104 (e.g., during slots allocated for downlink transmission, labeled as “D”).

For instance, during a configured grant (CG) opportunity at slot 6, the UE 102 is configured to transmit uplink data to the base station 104. In general, CG opportunities are periodic time intervals configured by the network (e.g., via the base station 104) during which the UE 102 can transmit data to the network, such as on a physical uplink shared channel (PUSCH).

Further, during the CDRX ON duration, the UE 102 can monitor the PDCCH for control information from the base station 104 (e.g., during the slots allocated for downlink transmissions, slots 7-9). In this example, the UE 102 receives control information on the PDCCH during the slot 7, and continues to monitor the PDCCH until the expiration of an inactivity timer (e.g., a network configured value) at slot 9. Upon expiration of the inactivity timer, the UE 102 enters a sleep state at slot 10.

Further, upon the completion of the CG opportunity at slot 6, the UE 102 starts a drx-HARQ-RTT (Discontinuous Reception Hybrid Automatic Repeat Request Round Trip Timer) (e.g., a network configured value) at slot 9. Upon expiration of drx-HARQ-RTT, the UE awakes from the sleep state and begins a DRX retransmission timer (e.g., a network configured value) at slot 11. During the span of the DRX retransmission transmitter, the UE 102 can transmit data to the base station 104 (e.g., during slots allocated for uplink transmission) and/or receive data from the base station 104 (e.g., during slots allocated for downlink transmission). For example, the UE 102 can transmit data to the base station 104 during a second CG opportunity at slot 16.

Upon the completion of the CG opportunity at slot 16, the UE 102 starts a drx-HARQ-RTT at slot 17. During the slots between the end of the DRX retransmission timer and the expiration of the drx-HARQ-RTT (i.e., slots 19 and 20), the UE re-enters the sleep state.

Further, upon expiration of drx-HARQ-RTT, the UE awakes from the sleep state and begins a DRX retransmission timer at slot 21. As described above, during the span of the DRX retransmission transmitter, the UE 102 can transmit data to the base station 104 (e.g., during slots allocated for uplink transmission) and/or receive data from the base station 104 (e.g., during slots allocated for downlink transmission). For example, the UE 102 can transmit data to the base station 104 during a third CG opportunity at slot 26.

In this example, the UE 102 is in a sleep state for three slots (i.e., slots 10, 19, and 20), but is otherwise in an awake state.

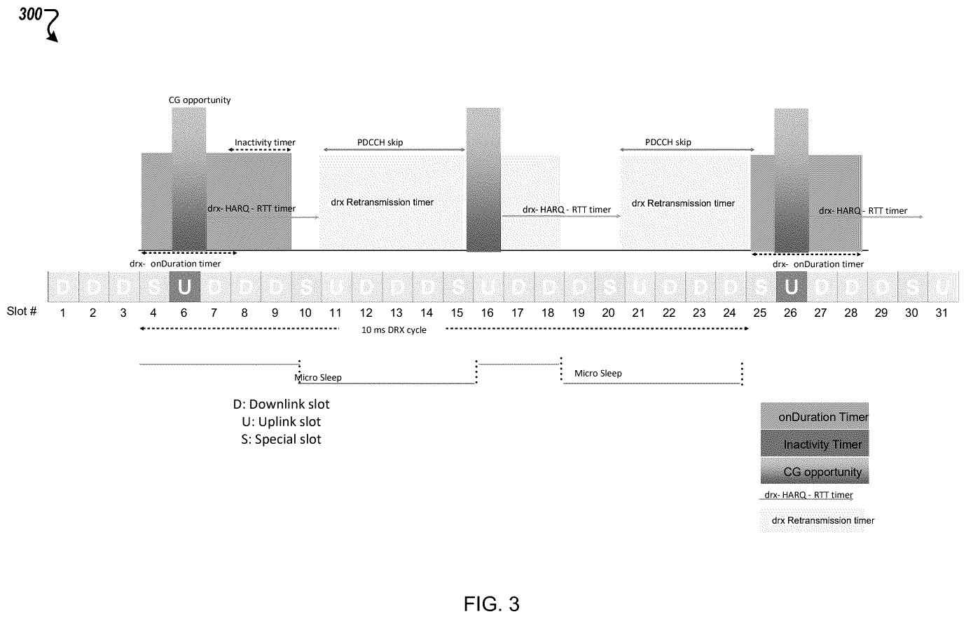

To reduce its power consumption, in at least some implementations, the UE 102 can enter a sleep state during additional slots, and refrain from monitoring the PDDCH during that time. For example, in at least some implementations, the UE 102 can enter a low-power state during a PDCCH skip interval during which the UE 102 does not monitor the PDCCH for control information from the base station 104. Further, the PDCCH skip interval can be aligned (e.g., in time) with the DRX retransmission timer). As an illustrative example, FIG. 3 shows a simplified representation of operations 300 of the UE 102 during CDRX operation with PDCCH skipping.

In general, the operations 300 are similar to the operations described with reference to FIG. 2. However, in this example, the UE 102 is configured to perform PDCCH skipping during one or more PDCCH skip intervals. Each PDCCH skip interval begins at the start of the DRX retransmission timer, and ends at (i) the beginning of a next CG opportunity and/or (ii) the beginning of a next CDRX ON duration.

As an example, upon expiration of drx-HARQ-RTT at slot 10, the UE begins a DRX retransmission timer at slot 11. Correspondingly, a PDCCH skip interval begins at slot 11, and ends at slot 15 (just prior to the beginning of the next CG opportunity at slot 16). From slots 10 to slot 15, the UE 102 remains in a sleep state. Further, during this time, the UE 102 does not monitor the PDCCH for any control signals information from the base station 104.

As another example, upon expiration of drx-HARQ-RTT at slot 20, the UE begins a DRX retransmission timer at slot 21. Correspondingly, a PDCCH skip interval begins at slot 21, and ends at slot 24 (just prior to the beginning of the DRX ON duration at slot 25). From slots 19 to slot 24, the UE 102 remains in a sleep state. Further, during this time, the UE 102 does not monitor the PDCCH for any control signals information from the base station 104.

In the example shown in FIG. 3, the UE 102 is in a sleep state for 12 slots (i.e., slots 10-15 and 19-24). Thus, by performing PDCCH skipping in accordance with the operations of FIG. 3, the UE 102 can reduce its consumption of energy (e.g., compared to the amount of energy that would be consumed by performing the operation of FIG. 2 instead).

In some implementations, PDCCH skipping can be explicitly configured by the network (e.g., via the base station 104).

For example, in some implementations, the UE 102 can perform PDCCH skipping if it is configured by the network with a low latency bearer and/or low latency Quality of Service Class Identifier (QCI) (e.g., a Fifth Generation Quality of Service Identifier, 5Q1). In some implementations, a low latency bearer and/or low latency can correspond to a 5QI value of 80 (5Q180).

In some implementations, the network can configure PDCCH skipping with a PDCCH skip interval having a duration that is equal to the DRX retransmission timer minus N slots, while the DRX retransmission timer is running. In particular, the value of N can be specified according to the following relationship:”

$$N = A - B \vert C ,$$

where A is the starting slot of DRX retransmission timer, B is the starting slot of the next CG occasion, and C is the starting slot of the next DRX ON duration timer.

In some implementations, if (i) there is downlink data buffered by the network (e.g., the base station 104) for transmission to the UE 102, or (ii) if an initial transmission, retransmission grant is pending, the base station 104 can transmit data and/to assign a grant to the UE during the Active DRX retransmission time when PDCCH skipping is not enabled.

In some implementations, PDCCH skipping may be implicitly configured (e.g., such that the UE 102 and the BS 104 autonomously operate in accordance with PDCCH skipping without explicit signaling to do so).

In some implementations, if the UE 102 is configured with only low latency bearer/low latency QCI (e.g., 5QI 80), the network (e.g., via the base station 104) may configure PDCCH skipping with a PDCCH skip interval that is equal to the DRX retransmission timer.

Further, after a CG transmission, during the DRX retransmission timer, the UE may not monitor PDCCH and the network may not be expected to signal a PDCCH skipping downlink control information (DCI), as skipping is implicit.

In some implementations, CG resource allocation may be such that it enables transmission of a single voice packet with high reliability. For example, the CG periodicity may match the packet arrival rate. The high reliability ensures that retransmission is unlikely to be needed. Further, even if a first transmission of the packet is not successful, retransmission may be attempted when the UE 102 is in the DRX ON duration (Active Time) or CG Active Time when DRX retransmission timer is running.

In some implementations, the detection of retransmissions and the assignment of a retransmission grant may be performed 5 milliseconds after the first transmission.

In some implementations, PDCCH skipping may be implicitly configured with Reference Signal Receive Power (RSRP) based control. For example, in some implementations, autonomous PDCCH skipping (e.g., a described above) may be performed only if the RSRP is higher than a pre-determined threshold. The RSRP may be determined based on last measurement report transmitted by the UE 102, and a skipping decision may be allowed at the next DRX ON duration after transmission of the measurement report.

In general, the embodiments described herein can be implemented in the context of using LTE networks, 5G NR networks, or a combination thereof. As an example, PDCCH skipping can be explicitly configured by the network in the context of a 5G NR network (e.g., by a NG RAN node such as a gNB). As another example, PDCCH skipping can be implicitly configured in the context of an LTE network (e.g., to facilitate communications between a UE and an E-UTRAN node, such as an eNB) and/or a 5G NR network (e.g., to facilitate communications between a UE and an NG RAN node, such as a gNB).

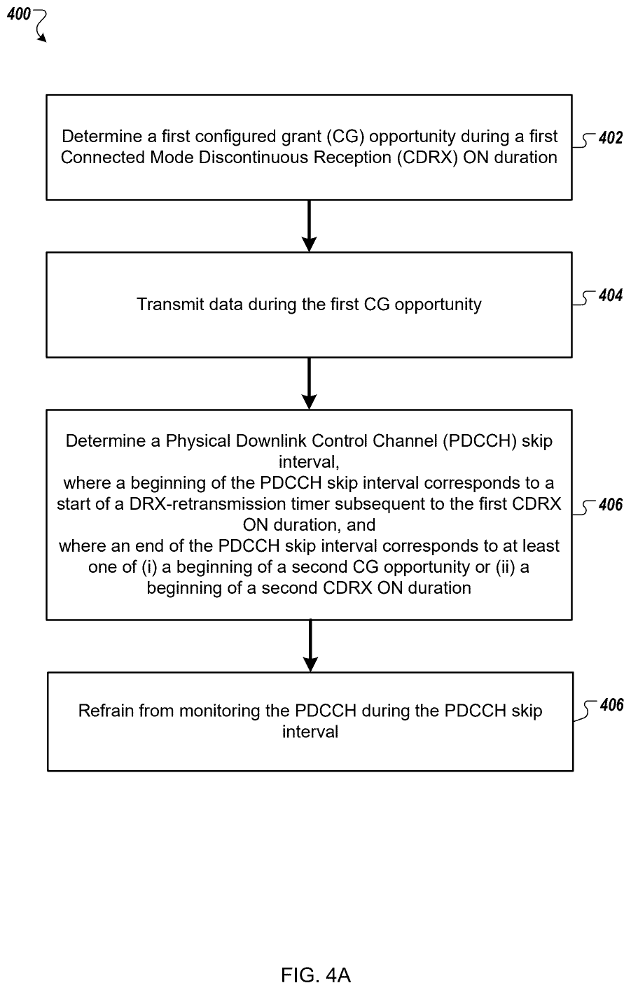

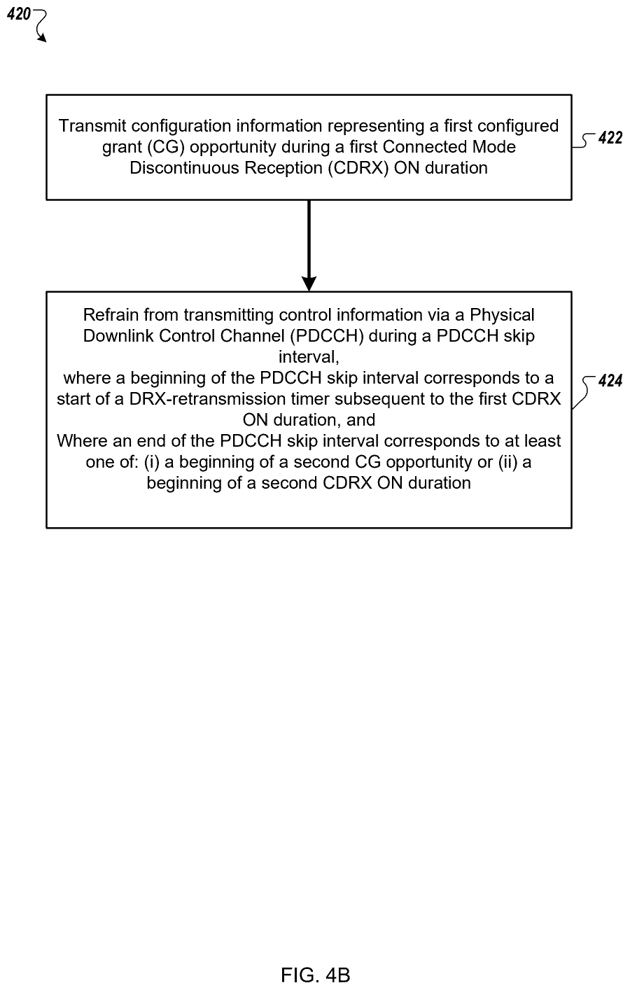

FIG. 4A illustrates a flowchart of an example method 400, according to some implementations. For clarity of presentation, the description that follows generally describes method 400 in the context of the other figures in this description. For example, method 400 can be performed by the UE 102 of FIG. 1. It will be understood that method 400 can be performed, for example, by any suitable system, environment, software, hardware, or a combination of systems, environments, software, and hardware, as appropriate. In some implementations, various steps of method 400 can be run in parallel, in combination, in loops, or in any order.

According to the method 400, an apparatus or system determines a first configured grant (CG) opportunity during a first Connected Mode Discontinuous Reception (CDRX) ON duration (402).

Further, the apparatus or system transmits data during the first CG opportunity (404).

Further, the apparatus or system determines a Physical Downlink Control Channel (PDCCH) skip interval (406). A beginning of the PDCCH skip interval corresponds to a start of a DRX-retransmission timer subsequent to the first CDRX ON duration. An end of the PDCCH skip interval corresponds to (i) a beginning of a second CG opportunity and/or (ii) a beginning of a second CDRX ON duration. In some implementations, the end of the PDCCH skip interval corresponds to an earlier one of (i) the beginning of the second CG opportunity or (ii) the beginning of the second CDRX ON duration.

Further, the apparatus or system determines a Physical Downlink Control Channel (PDCCH) skip interval (406). A beginning of the PDCCH skip interval corresponds to a start of a DRX-retransmission timer subsequent to the first CDRX ON duration. An end of the PDCCH skip interval corresponds to (i) a beginning of a second CG opportunity and/or (ii) a beginning of a second CDRX ON duration. In some implementations, the end of the PDCCH skip interval corresponds to an earlier one of (i) the beginning of the second CG opportunity or (ii) the beginning of the second CDRX ON duration.

Further, the apparatus or system refrains from monitoring the PDCCH during the PDCCH skip interval (408).

The method 400 can include one or more of the following features.

In some implementations, a determination to refrain from monitoring the PDCCH during the PDCCH skip interval can be made absent signaling from a network regarding a PDCCH skip configuration. For example, the apparatus or system can infer, based on an absence of explicit signaling regarding PDCCH skip, that PDCCH skip should be performed.

In some implementations, a determination to refrain from monitoring the PDCCH during the PDCCH skip interval can be made based on a Reference Signal Receive Power (RSRP) measurement.

In some implementations, the determination to refrain from monitoring the PDCCH during the PDCCH skip interval can be made based on a determination that the RSRP measurement is higher than a threshold value.

In some implementations, a PDCCH is not monitored during the PDCCH skip interval.

In some implementations, the method 400 can include performing micro sleep during the PDCCH skip interval.

In some implementations, the method 400 can include starting a Discontinuous Reception Hybrid Automatic Repeat Request Round Trip Timer (DRX-HARQ-RTT) at an end of the first CG opportunity. The beginning of the PDCCH skip interval can correspond to an expiration of the DRX-HARQ-RTT.

In some implementations, the method 400 can include receiving, during an active DRX retransmission time, at least one of downlink data or a transmission grant. The active DRX retransmission time can be between the first CDRX ON duration and the PDCCH skip interval.

In some implementations, determining the PDCCH skip interval can be based on determining a configuration with at least one of (i) a low latency bearer or (ii) a low latency Quality of Service Class Identifier (QCI) or Fifth Generation Quality of Service Identifier (5QI).

In some implementations, at least one of the low latency bearer or the low latency QCI can correspond to a 5QI value of 80.

In some implementations, the method 400 can include transmitting data to the network during the first CG opportunity.

In some implementations, the method 400 can be performed by one or more baseband processors.

In some implementations, the method 400 can be performed by the UE.

FIG. 4B illustrates a flowchart of an example method 420, according to some implementations. For clarity of presentation, the description that follows generally describes method V200 in the context of the other figures in this description. For example, method 4200 can be performed by the base station 104 of FIG. 1. It will be understood that method 4200 can be performed, for example, by any suitable system, environment, software, hardware, or a combination of systems, environments, software, and hardware, as appropriate. In some implementations, various steps of method 4200 can be run in parallel, in combination, in loops, or in any order.

According to the method 420, an apparatus or system transmits configuration information representing a first configured grant (CG) opportunity during a first Connected Mode Discontinuous Reception (CDRX) ON duration (422).

Further, the apparatus or system refrains from transmitting control information via a Physical Downlink Control Channel (PDCCH) during a PDCCH skip interval (424). A beginning of the PDCCH skip interval corresponds to a start of a DRX-retransmission timer subsequent to the first CDRX ON duration. An end of the PDCCH skip interval corresponds to at (i) a beginning of a second CG opportunity and/or (ii) or a beginning of a second CDRX ON duration. In some implementations, the end of the PDCCH skip interval corresponds to an earlier one of (i) the beginning of the second CG opportunity or (ii) the beginning of the second CDRX ON duration.

The method 420 can include one or more of the following features.

In some implementations, the method 420 can also include refraining from transmitting explicit signaling regarding a PDCCH skip configuration.

In some implementations, the method 420 can be performed by one or more baseband processors of a base station.

In some implementations, a Discontinuous Reception Hybrid Automatic Repeat Request Round Trip Timer (DRX-HARQ-RTT) can be started at an end of the first CG opportunity. The beginning of the PDCCH skip interval can correspond to an expiration of the DRX-HARQ-RTT.

In some implementations, the method 420 can include determining that least one of: (i) downlink data is buffered, or (ii) a retransmission grant is pending transmission. Further, in response, the apparatus or system can transmit, during an active DRX retransmission time, at least one of the downlink data or the retransmission grant, where the active DRX transmission time is between the first CDRX ON duration and the PDCCH skip interval.

In some implementations, the refraining from transmitting the control information via the PDCCH during the PDCCH skip interval can be based on a prior transmission of configuration information representing at least one of (i) a low latency bearer or (ii) a low latency Quality of Service Class Identifier (QCI) or Fifth Generation Quality of Service Identifier (5QI).

In some implementations, at least one of the low latency bearer or the low latency QCI can correspond to a 5QI value of 80.

In some implementations, the method 429 can include receiving data during the first CG opportunity.

In some implementations, the method 420 can be performed by one or more baseband processors.

In some implementation, the method 420 can be performed by a base station of the network.

The example methods 400 and 420 in FIGS. 4A and 4B, respectively can be modified or reconfigured to include additional, fewer, or different steps (not shown in FIGS. 4A or 4B), which can be performed in the order shown or in a different order.

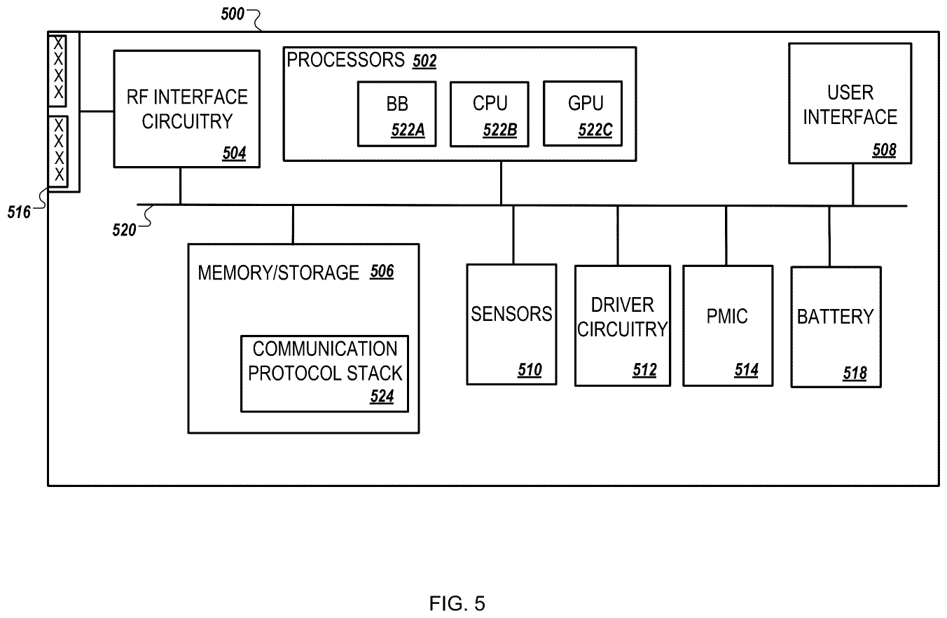

FIG. 5 illustrates an example UE 500, according to some implementations. The UE 500 may be similar to and substantially interchangeable with UE 102 of FIG. 1.

The UE 500 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 500 may include processors 502, RF interface circuitry 504, memory/storage 506, user interface 508, sensors 510, driver circuitry 512, power management integrated circuit (PMIC) 514, one or more antenna(s) 516, and battery 518. The components of the UE 500 may be implemented as integrated circuits (ICs), portions thereof, discrete electronic devices, or other modules, logic, hardware, software, firmware, or a combination thereof. The block diagram of FIG. 5 is intended to show a high-level view of some of the components of the UE 500. However, some of the components shown may be omitted, additional components may be present, and different arrangement of the components shown may occur in other implementations.

The components of the UE 500 may be coupled with various other components over one or more interconnects 520, which may represent any type of interface, input/output, bus (local, system, or expansion), transmission line, trace, optical connection, etc., that allows various circuit components (on common or different chips or chipsets) to interact with one another.

The processors 502 may include processor circuitry such as, for example, baseband processor circuitry (BB) 522A, central processor unit circuitry (CPU) 522B, and graphics processor unit circuitry (GPU) 522C. The processors 502 may include any type of circuitry or processor circuitry that executes or otherwise operates computer-executable instructions, such as program code, software modules, or functional processes from memory/storage 506 to cause the UE 500 to perform operations as described herein.

In some implementations, the baseband processor circuitry 522A may access a communication protocol stack 524 in the memory/storage 506 to communicate over a 3GPP compatible network. In general, the baseband processor circuitry 522A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 504. The baseband processor circuitry 522A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 506 may include one or more non-transitory, computer-readable media that includes instructions (for example, communication protocol stack 524) that may be executed by one or more of the processors 502 to cause the UE 500 to perform various operations described herein. The memory/storage 506 include any type of volatile or non-volatile memory that may be distributed throughout the UE 500. In some implementations, some of the memory/storage 506 may be located on the processors 502 themselves (for example, L1 and L2 cache), while other memory/storage 506 is external to the processors 502 but accessible thereto via a memory interface. The memory/storage 506 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 504 may include transceiver circuitry and radio frequency front module (RFEM) that allows the UE 500 to communicate with other devices over a radio access network. The RF interface circuitry 504 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 516 and proceed to filter and amplify (with a low-noise amplifier) the signal. The signal may be provided to a receiver of the transceiver that downconverts the RF signal into a baseband signal that is provided to the baseband processor of the processors 502.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 516. In various implementations, the RF interface circuitry 504 may be configured to transmit/receive signals in a manner compatible with NR access technologies.

The antenna(s) 516 may include one or more antenna elements to convert electrical signals into radio waves to travel through the air and to convert received radio waves into electrical signals. The antenna elements may be arranged into one or more antenna panels. The antenna(s) 516 may have antenna panels that are omnidirectional, directional, or a combination thereof to enable beamforming and multiple input, multiple output communications. The antenna(s) 516 may include microstrip antennas, printed antennas fabricated on the surface of one or more printed circuit boards, patch antennas, phased array antennas, etc. The antenna(s) 516 may have one or more panels designed for specific frequency bands including bands in FR1 or FR2.

The user interface 508 includes various input/output (I/O) devices designed to enable user interaction with the UE 500. The user interface 508 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 500.

The sensors 510 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 512 may include software and hardware elements that operate to control particular devices that are embedded in the UE 500, attached to the UE 500, or otherwise communicatively coupled with the UE 500. The driver circuitry 512 may include individual drivers allowing other components to interact with or control various input/output (I/O) devices that may be present within, or connected to, the UE 500. For example, driver circuitry 512 may include a display driver to control and allow access to a display device, a touchscreen driver to control and allow access to a touchscreen interface, sensor drivers to obtain sensor readings of sensors 510 and control and allow access to sensors 510, drivers to obtain actuator positions of electro-mechanic components or control and allow access to the electro-mechanic components, a camera driver to control and allow access to an embedded image capture device, audio drivers to control and allow access to one or more audio devices.

The PMIC 514 may manage power provided to various components of the UE 500. In particular, with respect to the processors 502, the PMIC 514 may control power-source selection, voltage scaling, battery charging, or DC-to-DC conversion.

In some implementations, the PMIC 514 may control, or otherwise be part of, various power saving mechanisms of the UE 500. A battery 518 may power the UE 500, although in some examples the UE 500 may be mounted deployed in a fixed location, and may have a power supply coupled to an electrical grid. The battery 518 may be a lithium ion battery, a metal-air battery, such as a zinc-air battery, an aluminum-air battery, a lithium-air battery, and the like. In some implementations, such as in vehicle-based applications, the battery 518 may be a typical lead-acid automotive battery.

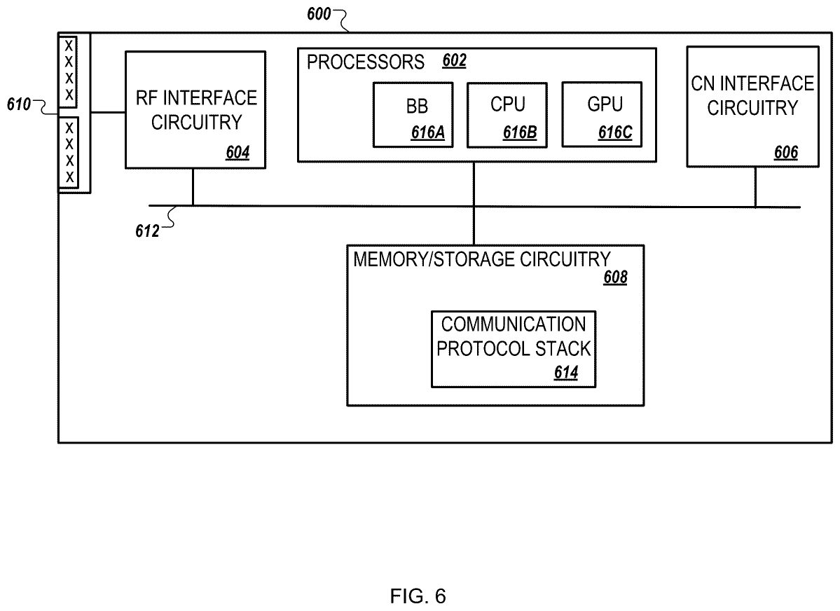

FIG. 6 illustrates an example access node 600 (e.g., a base station or gNB), according to some implementations. The access node 600 may be similar to and substantially interchangeable with base station 104. The access node 600 may include processors 602, RF interface circuitry 604, core network (CN) interface circuitry 606, memory/storage circuitry 608, and one or more antenna(s) 610.

The components of the access node 600 may be coupled with various other components over one or more interconnects 612. The processors 602, RF interface circuitry 604, memory/storage circuitry 608 (including communication protocol stack 614), antenna(s) 610, and interconnects 612 may be similar to like-named elements shown and described with respect to FIG. 5. For example, the processors 602 may include processor circuitry such as, for example, baseband processor circuitry (BB) 616A, central processor unit circuitry (CPU) 616B, and graphics processor unit circuitry (GPU) 616C.

The CN interface circuitry 606 may provide connectivity to a core network, for example, a 5th Generation Core network (5GC) using a 5GC-compatible network interface protocol such as carrier Ethernet protocols, or some other suitable protocol. Network connectivity may be provided to/from the access node 600 via a fiber optic or wireless backhaul. The CN interface circuitry 606 may include one or more dedicated processors or FPGAs to communicate using one or more of the aforementioned protocols. In some implementations, the CN interface circuitry 606 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 600 that operates in an NR or 5G system (for example, a gNB), and the term “E-UTRAN node” or the like may refer to an access node 600 that operates in an LTE or 4G system (e.g., an eNB). According to various implementations, the access node 600 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 600 may be implemented as one or more software entities running on server computers as part of a virtual network, which may be referred to as a CRAN and/or a virtual baseband unit pool (vBBUP). In V2X scenarios, the access node 600 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

### EXAMPLES

In the following sections, further exemplary embodiments are provided.
Example A1 includes a method. The method includes determining a first configured grant (CG) opportunity during a first Connected Mode Discontinuous Reception (CDRX) ON duration; transmitting data during the first CG opportunity; and determining a Physical Downlink Control Channel (PDCCH) skip interval, where a beginning of the PDCCH skip interval corresponds to a start of a DRX-retransmission timer subsequent to the first CDRX ON duration, and where an end of the PDCCH skip interval corresponds to at least one of: a beginning of a second CG opportunity, or a beginning of a second CDRX ON duration.
Example A2 includes the method of Example A1. Further, in Example A2, a PDCCH is not monitored during the PDCCH skip interval.
Example A3 includes the method of Examples A1 or A2. Further, Example A3 includes performing micro sleep during the PDCCH skip interval.
Example A4 includes the method of any of Examples A1-A3. Further, Example A4 includes starting a Discontinuous Reception Hybrid Automatic Repeat Request Round Trip Timer (DRX-HARQ-RTT) at an end of the first CG opportunity, where the beginning of the PDCCH skip interval corresponds to an expiration of the DRX-HARQ-RTT.
Example A5 includes the method of any of Examples A1-A4. Further, Example A5 includes receiving, during an active DRX retransmission time, at least one of downlink data or a transmission grant, wherein the active DRX retransmission time is between the first CDRX ON duration and the PDCCH skip interval.
Example A6 includes the method of any of Examples A1-A5. Further, in Example A6, determining the PDCCH skip interval is based on determining a configuration with at least one of (i) a low latency bearer or (ii) a low latency Quality of Service Class Identifier (QCI) or Fifth Generation Quality of Service Identifier (5QI).
Example A7 includes the method of any of Examples A1-A6. Further, in Example A7, at least one of the low latency bearer or the low latency QCI corresponds to a 5QI value of 80.
Example A8 includes the method of any of Examples A1-A7. Further, Example A8includes transmitting data to the network during the first CG opportunity.
Example A9 includes the method of any of Examples A1-A8. Further, in Example A9, the end of the PDCCH skip interval corresponds to an earlier one of (i) the beginning of the second CG opportunity or (ii) the beginning of the second CDRX ON duration.
Example A10 includes the method of any of Examples A1-A9. Further, in Example A10, the method is performed by one or more baseband processors.
Example A11 includes the method of any of Examples A1-A10. Further, in Example A111, the method is performed by the UE.
Example B1 includes a method. The method includes: transmitting configuration information representing a first configured grant (CG) opportunity during a first Connected Mode Discontinuous Reception (CDRX) ON duration; and refraining from transmitting control information via a Physical Downlink Control Channel (PDCCH) during a PDCCH skip interval, where a beginning of the PDCCH skip interval corresponds to a start of a DRX-retransmission timer subsequent to the first CDRX ON duration, and where an end of the PDCCH skip interval corresponds to at least one of: a beginning of a second CG opportunity, or a beginning of a second CDRX ON duration.
Example B2 includes the method of Example B1. Further, in Example B2, a Discontinuous Reception Hybrid Automatic Repeat Request Round Trip Timer (DRX-HARQ-RTT) is started at an end of the first CG opportunity, and the beginning of the PDCCH skip interval corresponds to an expiration of the DRX-HARQ-RTT.
Example B3 includes the method of Examples B1 or B2. Further, Example B3 includes: determining that least one of: downlink data is buffered, or a retransmission grant is pending transmission; and in response, transmitting, during an active DRX retransmission time, at least one of the downlink data or the retransmission grant, where the active DRX transmission time is between the first CDRX ON duration and the PDCCH skip interval.
Example B4 includes the method of any of Examples B1-B3. Further, in Example B4, the refraining from transmitting the control information via the PDCCH during the PDCCH skip interval is based on a prior transmission of configuration information representing at least one of (i) a low latency bearer or (ii) a low latency Quality of Service Class Identifier (QCI) or Fifth Generation Quality of Service Identifier (5QI).
Example B5 includes the method of any of Examples B1-B4. Further, in Example B5, at least one of the low latency bearer or the low latency QCI corresponds to a 5QI value of 80.
Example B6 includes the method of any of Examples B1-B5. Further, Example B6 includes receiving data during the first CG opportunity.
Example B7 includes the method of any of Examples B1-B6. Further, in Example B7, the end of the PDCCH skip interval corresponds to an earlier one of (i) the beginning of the second CG opportunity or (ii) the beginning of the second CDRX ON duration.
Example B8 includes the method of any of Examples B1-B7. Further, in Example B8, the method is performed by one or more baseband processors.
Example B9 includes the method of any of Examples B1-B8. Further, in Example B9, the method is performed by a base station of the network.
Example C1 may include one or more non-transitory computer-readable media including instructions to cause an electronic device, upon execution of the instructions by one or more processors of the electronic device, to perform one or more elements of a method described in or related to any of Examples A1-A1 and/or B1-B9, or any other method or process described herein.
Example D1 may include an apparatus including logic, modules, and/or circuitry (e.g., processing circuitry) to perform one or more elements of a method described in or related to any of Examples A1-A1 and/or B1-B9, or any other method or process described herein.
Example D1 may include a method, technique, or process as described in or related to any of Examples A1-A1 and/or B1-B9, or portions or parts thereof.
Example F1 may include an apparatus including: one or more processors and one or more computer-readable media including instructions that, when executed by the one or more processors, cause the one or more processors to perform the method, techniques, or process as described in or related to any of Examples A1-A1 and/or B1-B9, or portions thereof.
Example G1 may include a signal as described in or related to any of Examples A1-A11 and/or B1-B9, or portions or parts thereof.
Example H1 may include a computer program including instructions, wherein execution of the program by a processing element is to cause the processing element to carry out the method, techniques, or process as described in or related to any of Examples A1-A11 and/or B1-B9, or portions thereof. The operations or actions performed by the instructions executed by the processing element can include the methods of any one of Examples A1-A11 and/or B1-B9.
Example I1 may include a method of communicating in a wireless network as shown and described herein.
Example J1 may include a system for providing wireless communication as shown and described herein. The operations or actions performed by the system can include the methods of any one of Examples A1-A11 and/or B1-B9.
Example K1 may include a device for providing wireless communication as shown and described herein. The operations or actions performed by the device can include the methods of any one of Examples A1-A1 and/or B1-B9.

The previously-described Examples A1-A1 and/or B1-B9 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of Examples A1-A11 and/or B1-B9.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A method comprising:
determining a first configured grant (CG) opportunity during a first Connected Mode Discontinuous Reception (CDRX) ON duration;
transmitting data during the first CG opportunity;
determining a Physical Downlink Control Channel (PDCCH) skip interval,
wherein a beginning of the PDCCH skip interval corresponds to a start of a DRX-retransmission timer subsequent to the first CDRX ON duration, and
wherein an end of the PDCCH skip interval corresponds to at least one of:
a beginning of a second CG opportunity, or
a beginning of a second CDRX ON duration; and
refraining from monitoring the PDCCH during the PDCCH skip interval.

2. The method of claim 1, wherein a determination to refrain from monitoring the PDCCH during the PDCCH skip interval is made absent signaling from a network regarding a PDCCH skip configuration.

3. The method of claim 1, wherein a determination to refrain from monitoring the PDCCH during the PDCCH skip interval is made based on a Reference Signal Receive Power (RSRP) measurement.

4. The method of claim 3, wherein the determination to refrain from monitoring the PDCCH during the PDCCH skip interval is made based on a determination that the RSRP measurement is higher than a threshold value.

5. The method of claim 1, further comprising performing micro sleep during the PDCCH skip interval.

6. The method of claim 1, further comprising:
starting a Discontinuous Reception Hybrid Automatic Repeat Request Round Trip Timer (DRX-HARQ-RTT) at an end of the first CG opportunity,
wherein the beginning of the PDCCH skip interval corresponds to an expiration of the DRX-HARQ-RTT.

7. The method of claim 1, further comprising:
receiving, during an active DRX retransmission time, at least one of downlink data or a transmission grant, wherein the active DRX retransmission time is between the first CDRX ON duration and the PDCCH skip interval.

8. The method of claim 1, wherein determining the PDCCH skip interval is based on determining a configuration with at least one of (i) a low latency bearer or (ii) a low latency Quality of Service Class Identifier (QCI) or Fifth Generation Quality of Service Identifier (5QI).

9. The method of claim 6, wherein at least one of the low latency bearer or the low latency QCI corresponds to a 5QI value of 80.

10. The method of claim 1, further comprising transmitting data to the network during the first CG opportunity.

11. The method of claim 1, wherein the end of the PDCCH skip interval corresponds to an earlier one of (i) the beginning of the second CG opportunity or (ii) the beginning of the second CDRX ON duration.

12. The method of claim 1, wherein the method is performed by one or more baseband processors.

13. The method of claim 1, wherein the method is performed by the UE.

14. An apparatus including:
one or more processors; and
one or more computer-readable media including instructions that, when executed by the one or more processors, cause the one or more processors to perform operations comprising:
determining a first configured grant (CG) opportunity during a first Connected Mode Discontinuous Reception (CDRX) ON duration;
transmitting data during the first CG opportunity;
determining a Physical Downlink Control Channel (PDCCH) skip interval;
wherein a beginning of the PDCCH skip interval corresponds to a start of a DRXretransmission timer subsequent to the first CDRX ON duration, and
wherein an end of the PDCCH skip interval corresponds to at least one of:
a beginning of a second CG opportunity, or
a beginning of a second CDRX ON duration; and
refraining from monitoring the PDCCH during the PDCCH skip interval.

15. The system of claim 14, wherein a determination to refrain from monitoring the PDCCH during the PDCCH skip interval is made absent explicit signaling from a network regarding a PDCCH skip configuration.

16. The system of claim 14, wherein a determination to refrain from monitoring the PDCCH during the PDCCH skip interval is made based on a Reference Signal Receive Power (RSRP) measurement.

17. The system of claim 16, wherein the determination to refrain from monitoring the PDCCH during the PDCCH skip interval is made based on a determination that the RSRP measurement is higher than a threshold value.

18. A method comprising:
transmitting configuration information representing a first configured grant (CG) opportunity during a first Connected Mode Discontinuous Reception (CDRX) ON duration; and
refraining from transmitting control information via a Physical Downlink Control Channel (PDCCH) during a PDCCH skip interval,
wherein a beginning of the PDCCH skip interval corresponds to a start of a DRX-retransmission timer subsequent to the first CDRX ON duration, and
wherein an end of the PDCCH skip interval corresponds to at least one of:
a beginning of a second CG opportunity, or
a beginning of a second CDRX ON duration.

19. The method of claim 18, further comprising:
refraining from transmitting explicit signaling regarding a PDCCH skip configuration.

20. The method of claim 18, wherein the method is performed by one or more baseband processors of a base station.
